(19) United States
(12) Patent Application Publication
(10) Pub. No.: US 2026/0179017 A1
(43) Pub. Date: Jun. 25, 2026

(54) SYSTEMS AND METHODS FOR WORKFLOW DEVELOPMENT AND EXECUTION ENVIRONMENT

(71) Applicant: Financial Industry Regulatory Authority, Inc., Washington DC, DC (US)

(72) Inventors: Timothy Howard Nats, Highlands Ranch, CO (US); Mark Nicholas Law, Austin, TX (US); Jason Paul Rogers, Ocoee, FL (US); Eric Bing-Hua Hu, Ashburn, VA (US); Adam Jason Levine, Gaithersburg, MD (US); Lavanya Gurumurthy, Ellicott City, MD (US)

(21) Appl. No.: 19/190,122

(22) Filed: Apr. 25, 2025

Related U.S. Application Data
(60) Provisional application No. 63/736,534, filed on Dec. 19, 2024.

(51) Int. Cl. G06Q 10/0633

(52) U.S. Cl. CPC G06Q 10/0633

(57) ABSTRACT

Systems and methods include an interactive environment to develop different workflows in accordance with various entry points, actions, decisions, questions, answers, and/or the like in order to guide one or more users through a decision making process, which may be based on certain thresholds to assess one or more risks or other outcomes. A corpus of information may be used to direct a workflow through a series of questions, decision points, and then subsequent questions and/or workflows based, at least in part, on analysis of various thresholds or conditions, which may be defined by the workflow and/or within the corpus. In this manner, users may generate individual workflows for a given assessment and then apply the workflow to a variety of different end users.

### CROSS-REFERENCE TO RELATED APPLICATIONS

This application claims priority to and the benefit of U.S. Provisional Patent Application No. 63/736,534, filed Dec. 19, 2024, titled “SYSTEMS AND METHODS FOR WORKFLOW DEVELOPMENT AND EXECUTION ENVIRONMENT,” the full disclosure of which is hereby incorporated by reference in its entirety for all purposes.

### BACKGROUND

### 1. Field of Disclosure

Embodiments of the present disclosure relate to interaction environments for developing, reviewing, and publishing one or more workflows. In particular, embodiments of the present disclosure may be used to develop a hierarchical workflow using a corpus of information.

### 2. Description of Related Art

Risk analysis, such as for financial services, is often manually performed using a set of steps associated with one or more organizations. The analysis may not be sufficiently normalized across organizations, which may lead to discrepancies based on who performs the analysis. For example, auditors may run through a series of steps based on prior knowledge, but the series of steps may be determined based on hundreds of pages of text to try and categorize risks over a variety of different categories. Moreover, the information used in the analysis may change over time, thereby causing prior work to potentially become obsolete and not reusable for future analysis.

### SUMMARY

Applicant recognized the problems noted above herein and conceived and developed embodiments of systems and methods, according to the present disclosure, for interaction environments.

In an embodiment, a computer-implemented method includes receiving an answer responsive to a question in a workflow associated with a risk assessment system. The computer-implemented method also includes determining, based at least in part on the answer and one or more thresholds, a decision along a first path of the workflow. The computer-implemented method further includes selecting, based at least in part on the decision, a second path associated with a second workflow. The computer-implemented method also includes launching the second workflow. The computer-implemented method further includes providing, to a user associated with the answer, an entry point for the second workflow.

In another embodiment, a system includes one or more processors to receive, within a workflow environment, a set of assets for executing one or more tasks along a workflow. The one or more processors may further receive, for at least a portion of the set of assets, contextual information describing features of the portion of the set of assets. The one or more processors may also receive access to one or more data sources associated with a target of the workflow. The one or more processors may generate a configuration file for the workflow based, at least in part, on the set of assets and the contextual information. The one or more processors may further generate, using the configuration file and one or more templates, an executable evaluation workflow.

In an embodiment, a method includes receiving, within a workflow environment, a set of assets for executing one or more tasks along a workflow. The method also includes receiving, for at least a portion of the set of assets, contextual information describing features of the portion of the set of assets. The method further includes receiving access to one or more data sources associated with a target of the workflow. The method also includes generating a configuration file for the workflow based, at least in part, on the set of assets and the contextual information. The method includes generating, using the configuration file and one or more templates, an executable evaluation workflow.

### BRIEF DESCRIPTION OF DRAWINGS

The present technology will be better understood on reading the following detailed description of non-limiting embodiments thereof, and on examining the accompanying drawings, in which:

FIG. 1 illustrates an example environment for generating a workflow, in accordance with embodiments of the present disclosure;

FIG. 2 illustrates an example workflow environment for generating and publishing a workflow, in accordance with embodiments of the present disclosure;

FIG. 3A illustrates an example hierarchical representation of a workflow, in accordance with embodiments of the present disclosure;

FIG. 3B illustrates an example decision analysis process, in accordance with embodiments of the present disclosure;

FIG. 3C illustrates an example decision analysis process, in accordance with embodiments of the present disclosure;

FIG. 3D illustrates an example conditional analysis process, in accordance with embodiments of the present disclosure;

FIG. 3E illustrates an example decision analysis process, in accordance with embodiments of the present disclosure;

FIG. 4A illustrates an example interface for generating a workflow, in accordance with embodiments of the present disclosure;

FIG. 4B illustrates an example interface for generating a workflow, in accordance with embodiments of the present disclosure;

FIG. 4C illustrates an example interface for generating a component that may be integrated into a workflow, in accordance with embodiments of the present disclosure;

FIG. 4D illustrates an example interface for modifying a workflow with a component, in accordance with embodiments of the present disclosure;

FIG. 5 illustrates an example environment for dynamically adjusting a workflow, in accordance with embodiments of the present disclosure;

FIG. 6 illustrates an example environment for executing a workflow, in accordance with embodiments of the present disclosure;

FIG. 7A illustrates an example flow chart of a process for generating a workflow, in accordance with embodiments of the present disclosure;

FIG. 7B illustrates an example flow chart of a process for dynamically adjusting a workflow, in accordance with embodiments of the present disclosure;

FIG. 7C illustrates an example flow chart of a process for recognizing and recommending a component for a workflow, in accordance with embodiments of the present disclosure; and

FIG. 8 is an example configuration for a computing device, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure are directed toward systems and methods for generating workflows for execution by one or more users via one or more interactive environments. Various embodiments may provide an interactive environment to develop different workflows in accordance with various entry points, actions, decisions, questions, answers, and/or the like in order to guide one or more users through a decision making process, which may be based on certain thresholds to assess one or more risks or other outcomes. In at least one embodiment, a corpus of information may be used to direct a workflow through a series of questions, decision points, and then subsequent questions and/or workflows based, at least in part, on analysis of various thresholds or conditions, which may be defined by the workflow and/or within the corpus. In this manner, users may generate individual workflows for a given assessment and then apply the workflow to a variety of different end users. Embodiments may also incorporate one or more data analysis systems to import or otherwise fill information for one or more portions of the workflow, thereby reducing the load and/or work associated with the user executing the workflow.

Systems and methods of the present disclosure may be used to create workflow diagrams that define each step of the business decision flow (e.g., a workflow) for a given topic (e.g., risk topic, analysis topic, etc.) through a series of questions to evaluate and complete or conclude the selected assessment. Various embodiments may enable one or more users to author questions for each step and define or otherwise establish control logic that directs the flow from the starting entry point through either the conclusion (stopping) of the topic review, escalating the flow to a new tier level, or entering a rule citation. One or more portions of the workflow may define the data required and threshold values needed to answer questions. Furthermore, users may establish different portions of the workflow to provide written introduction and guidance to assist an end user in populating answers, collecting data, and/or the like. Embodiments may also incorporate one or more machine learning systems, such as a large language model (LLM) or a vision language model (VLM), as non-limiting examples, to generate a narrative for possible findings associated with the workflow that can be used to generate a report for one or more outcomes associated with the evaluation. As discussed herein, systems and methods may provide in-line data to support answering each question and further provide suggested “dispositions” (outcomes) during the answering of questions, at the conclusion of an individual portion of an assessment, and/or at the conclusion of all assessments and the overall exam. For embodiments directed toward risk assessment, such as with financial risk evaluation, systems and methods may provide an overall risk and/or risks along with an execution sequence plan that may be dynamically updated through execution based on the outcome of each individual topic associated with the examination. In this manner, new topics or sections may be dynamically added or removed based on previous interactions and/or answers. Embodiments may further provide an approval process in which one or more determinations may escalate a given evaluation. By identifying escalations early, time spent on an evaluation may be reduced. In at least one embodiment, an interactive environment may be provided to develop a workflow and then generate a standardized appearance for the workflow for execution by one or more downstream users.

Embodiments of the present disclosure may address and overcome problems with existing evaluation and/or auditing systems that often rely on written document sets that may be hard to use with respect to identifying the appropriate questions and thresholds for evaluation. As a result, evaluations are performed on an ad hoc basis for individual users, leading to long lead times for generation and completion. Systems and methods provide a tool to generate workflows using a corpus of information to identify relevant questions, important thresholds for different decisions, and guide a workflow through various paths (e.g., one or more flowlines) based on information obtained and/or extracted during an evaluation. For example, systems and methods may link sets of rules to an interactive environment that may enable auto-population and/or auto-determination of various factors in a workflow analysis by integrating data at the time the data is needed, thereby reducing time for completion and also reducing compute by potentially skipping or removing steps in an evaluation. Embodiments may further be used to generate standardized, repeatable, reliable assessment methods that can be applied across a variety of different industries.

One or more embodiments may be directed toward a business workflow toolset for examination teams that allows one or more users to create the exam content for each risk area being examined that is then used by an examination workspace to drive an interactive workflow experience to conduct exams. Systems and methods may enable content authorizing teams to generate sophisticated workflow diagrams that may be used to collect required information from examiners by authoring questions that exam execution teams will answer, incorporate those answers into follow on actions, and then provide an evaluation determination based on a series of steps and/or actions that proceed along the workflow. Embodiments may further include data analytics and data visualizations to assist examiners in answering questions, and, in certain embodiments, automatically answer questions using internally engineered data sources. The toolset may further enable teams to build decision logic that will drive the interactive application experience in the workspace to automatically and dynamically determine risk scope for an exam. Systems and methods may also include tools to provide a more interactive or engaging environment, which may include rich text and media (e.g., imagery, video, audio) guidance that is presented to examiners to educate and guide them through the examination process. Additionally, the workflows may be configured to trigger other ancillary actions, such as executing a task, sending a message, prompting a user for more information, or annotating an exam with important information. One or more embodiments may also incorporate automatic error checking with guaranteed workflow rule integrity and may provide a preview of the workflow before publishing to production. Embodiments may also use version history, version comparisons, and incorporate rollback/restore capabilities, thereby maintaining state information for ongoing or started evaluations, even if one or more evaluations changes at a later time. Additionally, the toolset may provide review and approval prior to publishing and offer collaborative commenting for workflow ideation, drafting, and reviewing. Systems and methods may also incorporate one-click publishing to production and availability and further introduce a self-service exam risk taxonomy manager. When assessments are completed, one or more LLMs or VLMs may be used to create 1) draft exam summary reports and 2) craft guidance content used by examiners within the workspace. Additionally, systems and methods may also incorporate an exam execution sequence planning service that uses artificial intelligence (AI) and/or machine learning (ML) techniques to dynamically update the scope and execution path of the exam based on the outcome of each workflow.

Various other such functions can be used as well within the scope of the various embodiments as would be apparent to one of ordinary skill in the art in light of the teachings and suggestions contained herein.

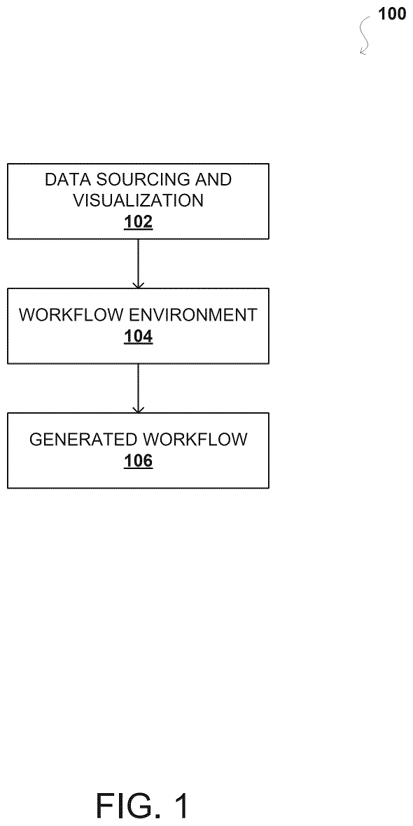

FIG. 1 illustrates a schematic representation of an embodiment of a system 100 that may be used with embodiments of the present disclosure. The illustrated system 100 may be incorporated into one or more interactive environments in which users may generate one or more workflows that may be used to perform an evaluation, such as a risk evaluation for a financial entity, as one non-limiting example. FIG. 1 includes a data sourcing and visualization engine 102, a workflow environment 104, and a generated workflow 106. In operation, the data sourcing and visualization environment 102 may be used to collect information from one or more data lakes, such as from a number of different datastores, which may all be collectively referred to as a corpus of information. The corpus of information may include a variety of different information that may be categorized into data fields for evaluation and/or used to generate one or more data visualizations. In at least one embodiment, the corpus of information may include, at least in part, information that is used to generate a guidance and content management system that may provide thresholds or other evaluation information for generation of the workflow and/or components thereof.

Further illustrated is the workflow environment 104, which may use information from the data sourcing and visualization engine 102 to generate the workflows 106. The workflow environment 104 may include an interactive environment in which one or more users may develop different business workflows through the use of a variety of tools including providing entry points, asking questions, executing decision points, and then proceeding along different paths of a workflow to eventually develop an action, which may include an answer to a question, a recommendation to perform a task, an escalation, and/or the like. Workflows may include a variety of different portions, which may include different subjects, topics, categories, etc., that may be organized to execute one or more actions based on input information. By way of example, a workflow to determine whether or not an entity is performing money laundering may be associated with a final action that provides a value or assessment regarding a risk or likelihood of money laundering. The workflow environment 104 may enable a user to generate a series or questions or evaluations to determine, for example based on proprietary thresholds, a likelihood or risk associated with a given entity for a given evaluation. In this manner, a uniform, consistent workflow may be generated to deterministically apply an evaluation.

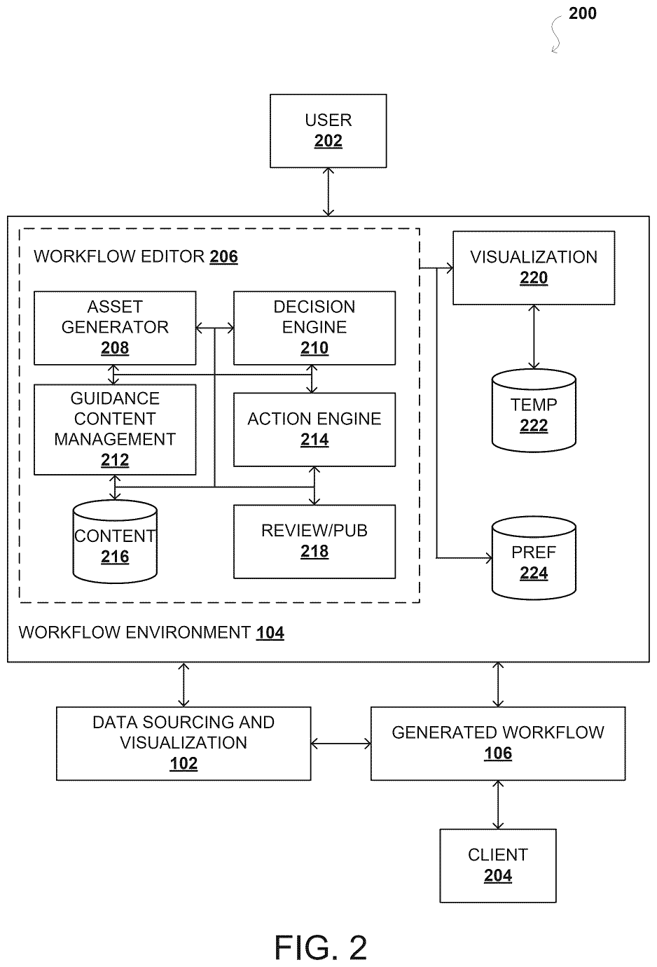

FIG. 2 illustrates an example environment 200 that may be used with embodiments of the present disclosure. In this example, one or more users 202 may interact with the workflow environment 104 to generate one or more workflows 106, which may then be used to execute an evaluation by one or more clients 204, as discussed herein. In operation, the one or more users 202 (e.g., user devices) may submit requests over one or more networks to access and/or use features associated with the application environment 102. The users 202 and/or clients 204 may represent one or more devices (e.g., user devices, user computing devices, client devices, client computing devices), which may serve as a proxy to the client/user by making requests responsive to one or more input commands. Additionally, a user/client may navigate to one or more applications or access points using the device to submit a request, among other options. As another example, a request may be transmitted as part of an automated or semi-automated workflow, which may or may not receive user/client interaction. Accordingly, one or more computing devices, associated with the one or more users 202 and/or one or more clients 204 may be used with respect to workflows that include direct input from one or more users/clients, from stored software instructions, from executions of various workflows, or combinations thereof.

Turning to the user 202, the user 202 may be authorized to access the workflow environment 104 in order to generate the one or more workflows 106, for example using a series of steps associated with an evaluation for risks in examples associated with financial services. The user 202 may interact with a workflow editor 206 in order to create a series of steps, which may include actions, decisions, entry points, answers, questions, etc. that may be visualized and provided as the one or more workflows 106. The illustrated workflow editor 206 may include one or more graphical icons or representations that permit the user 202 to select an appropriate symbol of icon to represent a step of the workflow, connect the icons in an appropriate sequence, and/or provide supplemental information, among other options.

The non-limiting example workflow editor 206 includes an asset generator 208, a decision engine 210, a guidance content management system (CMS) 212, an action engine 214, a content datastore 216, and a review/publication engine 218. While represented as separate components, various embodiments may be integrated or grouped under a common engine and/or interaction component. In this example, the asset generator 208 may be used to select different interactive components associated with the workflow. For example, the asset generator 208 may include icons for different portions of the workflow, such as actions, decisions, answers, etc. The user 202 may select a given icon from the asset generator 208 and then provide information associated with the selected asset. By way of example, the user 202 may provide a plain language description of a question, which may include a prompt for a client, a specification regarding units or format of the answers, and/or combinations thereof. As discussed herein, the assets may also be recommended and/or pre-selected based on a template or given workflow.

The decision engine 210 may be used to import or otherwise use one or more thresholds in order to evaluate information received within the workflow, which may be information provided by the client 204 and/or may be extracted directly from the data sourcing and visualization engine 102. The decision engine 210 may enable users 202 to establish different logical representations of input data and then generate different paths based, at least in part, on an outcome of the decision. For example, if an answer is presented with a YES/NO response, the decision may include a first path for a YES and a second path for a NO. In this manner, complex evaluations may be broken into logical evaluations of discrete data in order to generate a logical, easy to follow workflow. In one or more embodiments, the paths may be referred to as a “flowline,” which may refer to a graphical or logical connection between two or more objects (e.g., a programmable connection) to illustrate progression of flow from one element to the next. Flowlines are directed based on upstream decision outcomes with decisions to carry forward to the next element.

Systems and methods may also include the CMS 212 in order to provide recommendations or context for a given portion of the workflow. For example, the CMS 212 may be used to provide guidance for answering questions, such as including certain units (e.g., dollar amounts, units of time, etc.) or potential sources to find the information (e.g., a tax return, an SEC submission, etc.). Furthermore, the CMS 212 may also provide context to describe why the information is needed and to provide options if the information is not available, which may include starting a different workflow and/or triggering a higher level evaluation and review, among other options. In certain embodiments, data for the CMS 212 may be provided by the one or more content datastores 216, which may include content, which may be proprietary, to evaluate different workflows. For example, the content datastores 216 may include a set of thresholds for various decisions, a defined set of questions for a given topic or subtopic for one or more risks, and/or combinations thereof.

The illustrated action engine 214 may be used to execute follow on actions or processes within the workflow based on one or more upstream results, for example based on information provided by the client 204 and/or the data sourcing and visualization engine 102 and/or after a result is generated from the decision engine 210. The action engine 214 may progress to different topics or sub-topics, may initiate a higher level review, my move toward a different workflow, and/or the like. As discussed herein, certain embodiments may use the action engine 214 to change an order of evaluation based on the information provided and/or the upstream decisions. For example, a given topic may have multiple sub-topics and sub-topics may be evaluated in different orders based on upstream information, and/or may be skipped entirely based on the previous answers and/or decisions, thereby reducing compute and time to perform an evaluation. As discussed herein, one or more embodiments may use the action engine 214 to orchestrate actions performed on the generated workflow 106. Furthermore, in embodiments, the action engine 214 may be used to define follow on actions when generating the workflow 106.

The illustrated embodiment also includes the review and publication engine 218, which may evaluate different connections within the workflow to verify that answers are connected to subsequent decision points and/or to determine whether decisions lead to follow up actions, thereby preventing a “broken” link within a workflow from derailing and/or causing an error that would end the workflow prior to completion. The review and publication engine 218 may further be used for an upper level or management review, for example, to verify the workflow prior to publication for use by the clients 204. In this manner, the workflow editor 206 may be used to generate different workflows based, for example, on different evaluations.

The workflow environment 104 further illustrates a visualization engine 220 that may take the resultant workflow generated by the workflow editor 206, which may be in the form of a JSON file as one non-limiting example, and then generate a visualized flow that may be provided to the client 204, for example in the form of a web-app, among other options. One or more templates from a template datastore 222 may be used to format or otherwise present the workflow 106, which may be particularized based on one or more user preferences from a preference datastore 224. Accordingly, systems and methods may be used to generate different workflows that may be converted into viewable, interactable evaluations for different clients 204. Embodiments may further provide change tracking, to determine what changes were made, when, and by whom, and may “lock” or otherwise freezes versions for ongoing evaluations, thereby maintaining a given state for an evaluation at the time the evaluation was started.

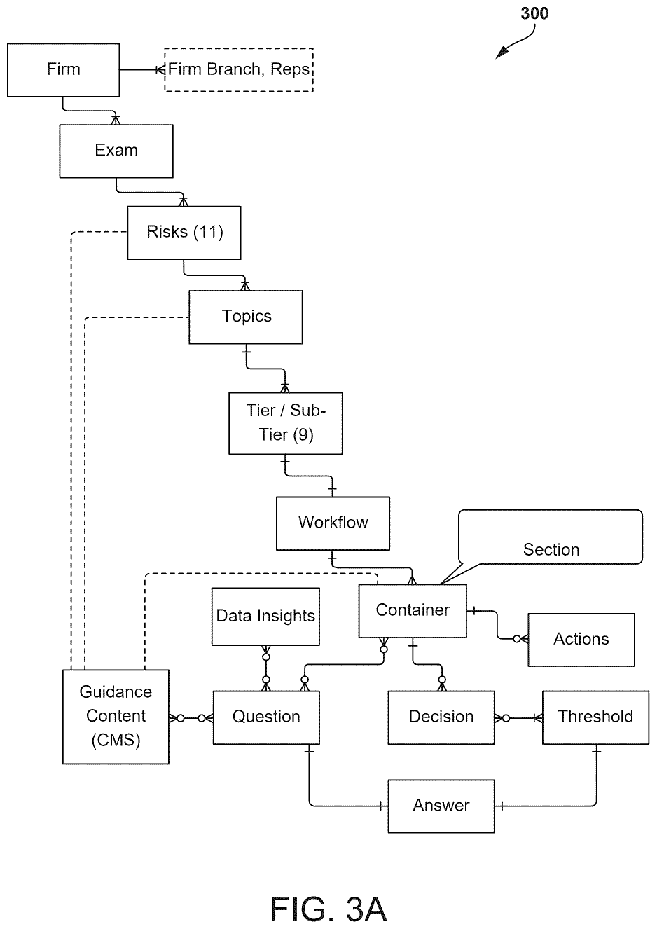

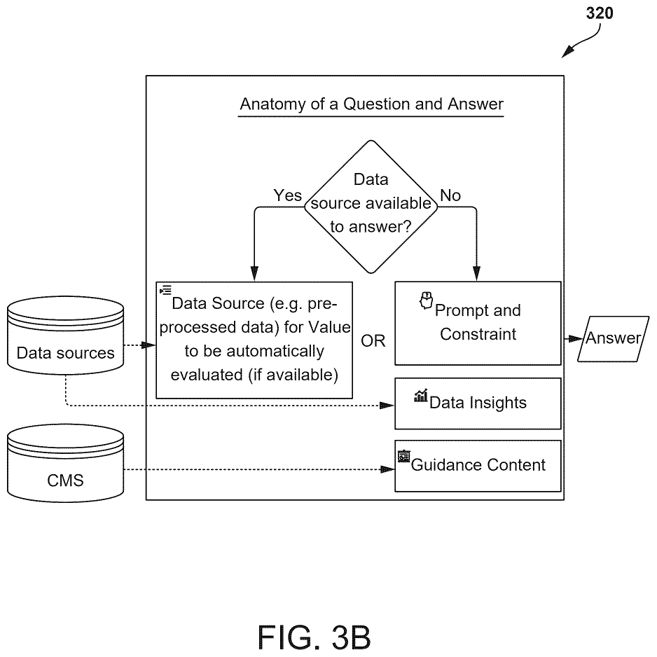

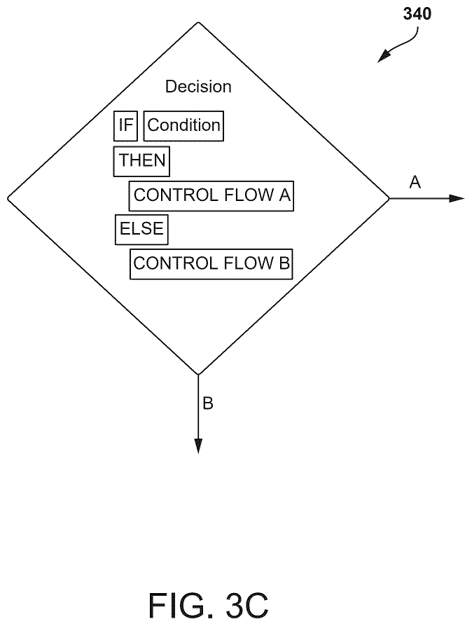

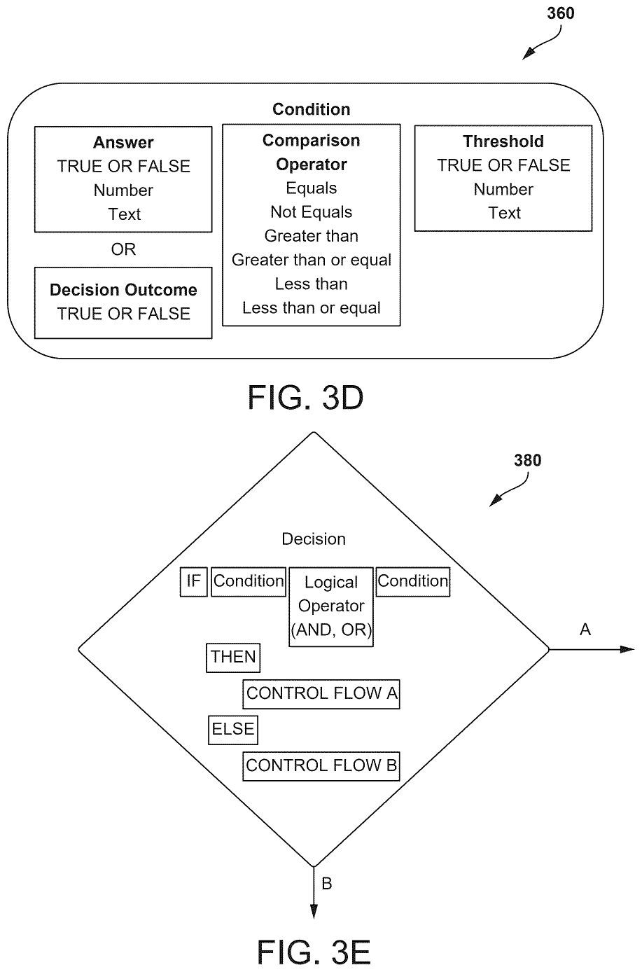

FIG. 3A illustrates an example representation 300 of a hierarchy that may be used to prepare a workflow. In this example, the hierarchy illustrates different levels, such as a firm (e.g., organization, company, etc.) that may be the subject of one or more exams. The exams may be developed based on various risks, which in this example includes 11 risks, but other examples may include more or fewer risks. The risks of the illustrated hierarchy may be a subset of potential exams or evaluations for analysis of organizational operations. The risks may be evaluated on a topic-by-topic basis, which may be informed by the CMS, as discussed herein. Additionally, the topics may further be segmented into individual tiers/sub-tiers, which includes the non-limiting example of 9 different tiers/sub-tiers in this example. Each of the risks, topics, and tiers/sub-tiers may then be prepared within the illustrated workflow, such as the workflow 106. The workflow may include different assets which may include questions, actions, decisions, thresholds, answers, and the like. A container may be used to group each of the assets together, which may further receive data insights in order to generate answers and/or actions based on input information. While various embodiments may discuss risk, it should be appreciated that systems and methods of the present disclosure may be applicable to a variety of different types of evaluations and may not necessarily be a type of risk evaluation.

FIG. 3B illustrates an example representation 320 of a question and answer workflow that may be used with embodiments of the present disclosure. In certain embodiments, systems and methods may be set to automatically provide an answer to a question. For example, a question may be established as part of a workflow, and it may be determined whether or not a dataset is available to answer the question. If so, then the data source may be queried and used to input the answer, thereby reducing cognitive load on clients executing the workflow. Additionally, in various embodiments, if the data source is not available, then a prompt may be provided to the client. As discussed herein, the prompt may provide guidance or insights to help the client evaluate the question and provide sufficient information. In this manner, systems and methods may perform an initial evaluation of a question to determine whether or not the user is even presented an option to fill in the answer, or if existing data may be used, and thereafter may generate an answer.

In one or more embodiments decision elements represent the evaluation of conditions and determine the next step in the workflow using control flows. A variety of different decisions may be presented with embodiments of the present disclosure, including as a non-limiting example IF/THEN/ELSE, where IF is used to test conditions and direct control flow from the decision, THEN is used to set the control flow if the condition(s) evaluate to TRUE, and ELSE is used to set the control flow if the condition(s) evaluate to FALSE. Conditions may be used to compare an answer, or a decision outcome, to a threshold using comparison operators. The result of a comparison may be a Boolean expression, such as TRUE or FALSE.

FIG. 3C illustrates an example representation 340 of a decision that may be defined by the decision engine 210, in accordance with one or more embodiments. In this example, the decision is associated with an IF/THEN/ELSE evaluation in which one or more conditions are evaluated to determine an appropriate path (e.g., the path A or the path B). The decisions may be defined by a variety of thresholds or other information, which may be proprietary or otherwise particularly selected for a given evaluation, risk, task, sub-task, or combination thereof. In certain embodiments, the decisions and underlying logic may be opaque to the client, thereby preserving confidentiality of the information used to generate a response to the decision.

In at least one embodiment, answers may be defined and supplied to questions within a workflow. For example, when an author (e.g., the user generating the workflow, the client executing the evaluation, etc.) selects the answer for the condition, it also assigns the same data type and constraints for the corresponding threshold value that is provided by the decision author. Accordingly, the value of the answer that was provided by any question will be compared to the threshold value during execution. The result of a decision (e.g., TRUE or FALSE) may be available to any subsequent decision in the current workflow or any workflow within an exam session. As a result, different evaluations may use information previously generated to conserve compute requirements and/or to streamline the process to remove repetitive entry from the client executing the workflow.

Various embodiments may perform evaluations using comparison operators that may include, as non-limiting examples, equals, not equals, greater than, greater than or equal, less than, less than or equal, and/or the like. Thresholds may be considered values defined in the decision that are used to compare against the answer. For example, if a condition with the prompt “Did the Firm process third-party transfers?” evaluated a user supplied value to test it was TRUE, then the condition would result in TRUE. Similarly, if a condition with the prompt “Did the Firm process third-party transfers?” evaluated a user supplied value to test it was FALSE, then the condition would result in FALSE. As another example, if a condition with the prompt “What is the Risk Monitoring Score for Money (Asset) Movement?” evaluated a user supplied value of 2 to test if was equal to 1 or 2, then various embodiments could proceed according to the workflow based on the evaluation of 2. As discussed herein, various values may be supplied by data sources that are linked to the evaluation process enabling automated answering and workflow progression. In one or more embodiments, clients executing a workflow may be provided a summary of automated answering, with the option to edit or otherwise modify the answers.

FIG. 3D illustrates an example representation 360 of different conditions that may be used with embodiments of the present disclosure. In this example, a variety of different types of answers are illustrated, including TRUE/FALSE, numerical, textual, and/or combinations thereof. For example, in order to simplify the evaluation process, embodiments of the present disclosure may present questions in a particular format to drive or otherwise guide the user toward a certain type of answer, such as only providing an option or a YES/NO or TRUE/FALSE or requesting information in a certain way, such as a dollar amount. Embodiments may also incorporate a number of different operators for evaluation, and may link operators, in order to evaluate the answer or information against one or more thresholds. In this manner, a decision may be developed and used for subsequent workflow processes.

One or more embodiments may also incorporate logical operators into evaluations and/or decisions when more than one condition is needed to make a decision. In at least one embodiment, a logical operator (e.g., AND, OR) is used combine any number of conditions. Accordingly, logical operators are used to combine multiple conditions together to determine if any are TRUE or all are TRUE. For example, with the decision of: IF Condition 1 AND Condition 2 AND Condition 3 are all true, then the IF would be evaluated as TRUE. As another example, with the decision of: IF Condition 1 OR Condition 2 OR Condition 3, then any condition may be TRUE for the IF to be evaluated as TRUE.

FIG. 3E illustrates an example representation 380 of a decision that may be defined by the decision engine 210, in accordance with one or more embodiments. In this example, the decision is associated with an IF/THEN/ELSE evaluation in which multiple conditions are evaluated to determine an appropriate path (e.g., the path A or the path B). The decisions may be defined by a variety of thresholds or other information, which may be proprietary or otherwise particularly selected for a given evaluation, risk, task, sub-task, or combination thereof. In certain embodiments, the decisions and underlying logic may be opaque to the client, thereby preserving confidentiality of the information used to generate a response to the decision.

Decisions may lead to various outcomes, and the decisions may be propagated throughout a given workflow and/or workflows associated with a given evaluation. Decisions may lead to actions, which may be considered elements that may trigger an event or re-direct the exam execution to another workflow. A variety of action types may be incorporated into embodiments of the present disclosure, such as workflow redirect, risk topic escalation, manager's approval, pause for resource review, messaging (e.g., send an email), annotations (e.g., citation), and the like.

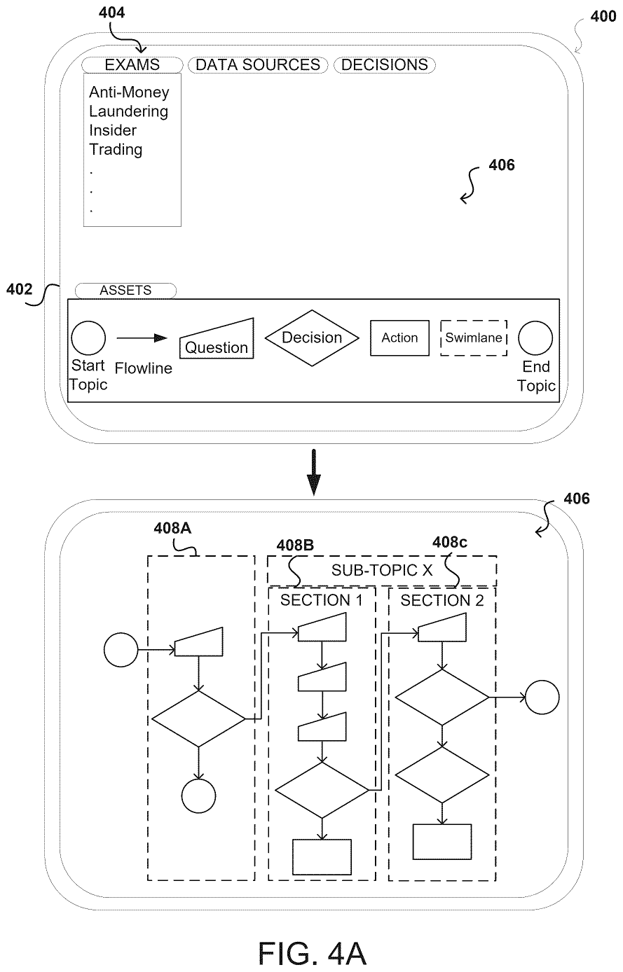

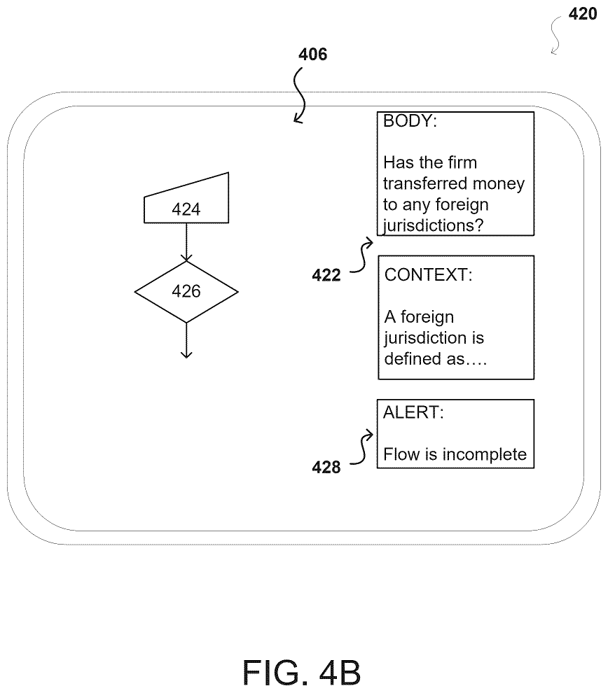

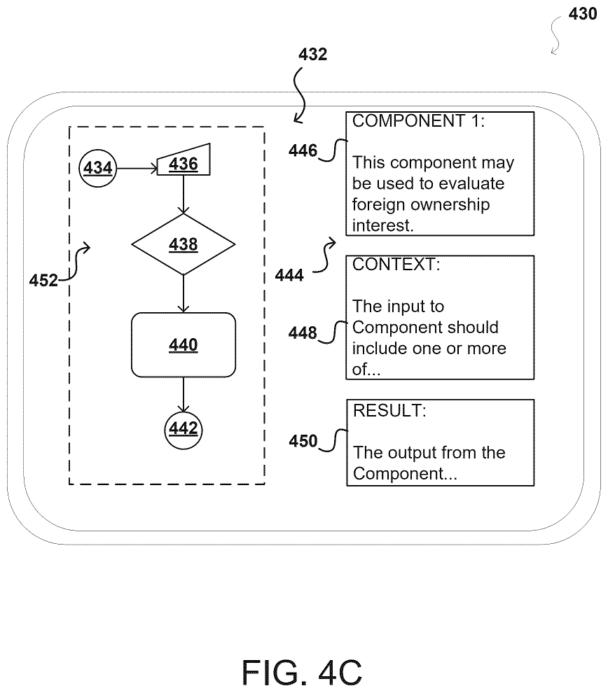

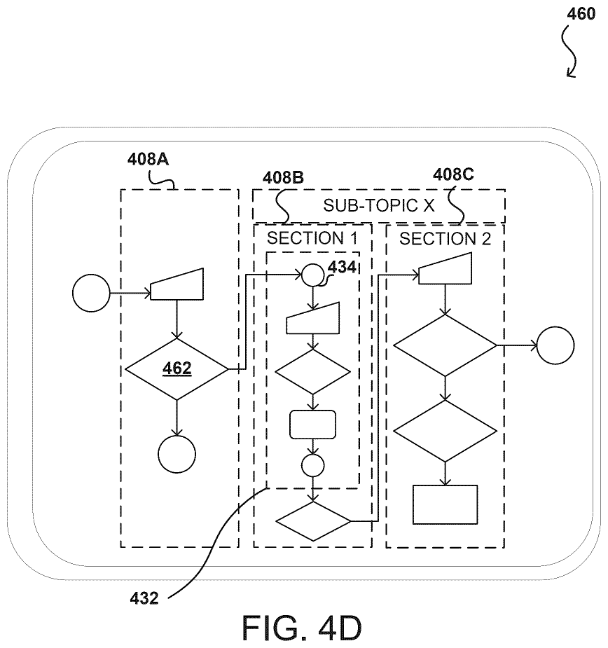

FIG. 4A illustrates an example representation and flow 400 that may be used with embodiments of the present disclosure. In this example, an interface 402 is illustrated that may show a graphical representation of a user interacting with the workflow environment 104, such as the workflow editor 206, in order to generate one or more workflows. This example includes selectable icons 404, which may be associated with different features or menus that may be used by the user, such as exams, data sources, decisions, and assets. For example, a given exam may provide a template of one or more flows or questions that a user may take as a starting point and/or modify based on a particular desired end evaluation. Additionally, different selectable assets are shown that may be positioned within a workspace 406, as shown to generate one or more flows.

The example flow includes different containers 408, which may be referred to as swim lanes, to section out different topics, sub-topics, sections, and/or the like. For example, an entry point 410 may be provided to a first container 408A, which includes assets 404 such as questions, decisions, and the like. By following the flow, the decision may lead to a second container 408B, which includes additional questions, decisions, and the like. Based on the decision points, the third container 408C may be activated, or an action may be executed to end the process. Users may build integrated workflows where different topics, sub-topics, sections, and/or the like flow into one another in a logical, organized fashion, with different data sources being used to populate certain categories. Additionally, as discussed herein, a client executing the workflow may be provided with additional supplemental information that may be provided by the user while generating the workflow.

FIG. 4B illustrates an example representation 420 that may be used with embodiments of the present disclosure in which a user is generating a workflow and providing additional information 422 associated with elements of the workflow. In this example, the user has added a question 424 and a decision block 426. To populate the question 424, the additional information includes the body text and also context for the question 424. For example, the context may include information as to why the question is being asked, how the question relates to the workflow, where to find the information, and/or the like. In this manner, the workflow may maintain a streamlined appearance while including large quantities of information that may be edited and adjusted over time. Additionally, the additional information 422 may be used by organizations to particularize their workflows based on specific organization style.

Individual assets within the workflow may also have metadata added to enforce complexity. For example, specific datatypes may be added to an individual asset, such as a desired input for a question or a desired output, thereby reducing errors where a user may inadvertently include the wrong information, which may cause problems in the downstream flow of the workflow.

Further illustrated is an alert 428, which may be provided to notify the user that the workflow is incomplete for having open ends and, as a result, the workflow may not be published or otherwise elevated for further review until the problems are addressed. Accordingly, embodiments may enforce workflow integrity and, in certain examples, still provide a human-in-the-loop reviewer to further analyze and evaluate the workflows.

One or more embodiments of the present disclosure may also be used to generate components, which may include a collection of workflow elements (e.g., assets) that may be created and then used repeatedly in more than one workflow. For example, a component may be used in a variety of different evaluations, and may be stored and then quickly reused and integrated into a new workflow, thereby providing a more efficient and streamlined workflow generation process. FIG. 4C illustrates an example environment 430 that may include one or more components 432. As discussed herein, different components 432 may include particular types of workflows or processes that can be integrated across a variety of workflows and/or may include building blocks that can be extended with one or more additional components.

In this example, the component 432 includes a start 434, a question 436, a decision point 438, an action 440, and an end 442. Upon receiving an input, for example from another component or as part of a workflow, a sequence of evaluations may commence through the component 432, with the component potentially performing one or more actions and then providing an output, which may then be integrated into other portions of the workflow.

The illustrated embodiment includes one or more features 444 for the component 432, including an overview 446 of a topic associated with the component 432, as well as recommended inlet information 448 and/or a description of a potential result or outlet 450. The one or more features 444 may refer to discrete, independent elements to describe one or more portions of the workflow. In at least one embodiment, the one or more features 444 may include textual information, data analytics, data visualizations, and/or the like. The example component 432 in FIG. 4C includes five different workflow elements 452 (e.g., the start 434, the question 436, the decision point 438, the action 440, and the end 442). One or more features 444 may be included for each of the workflow elements 452, for certain workflow elements 452, and/or for the component 452 as a whole. In operation, the one or more features 444 may include information used to assist an evaluator in making decisions along the workflow, such as identifying proper input information, answering questions, providing access to additional resources, and/or the like. In this manner, when generating a workflow, a user may rapidly identify and integrate the component 432, rather than building out a workflow individually, because the one or more features 444 may provide relevant information for the component 432 and/or the workflow elements 452 forming the component 432. One or more embodiments may include component suggestions as a user is generating a workflow, for example, based on one or more prompts presented to the user. For example, if a user is building out a workflow that includes evaluation of whether an entity has foreign bank accounts, systems and methods may identify one or more initial questions (e.g., the start 434 or the question 436) and may identify one or more relevant components 432 that may be integrated, rather than having the user continue to independently build out the component. Components 432 may be stored for individual entities, workflow types, and/or combinations thereof.

FIG. 4D illustrates an example environment 460 in which the component 432 is integrated into a workflow, such as the workflow of FIG. 4A. The component 432 in the illustrated example is not an independent section 408, such as the section 408B, or an individual swim lane, but instead serves as a portion that can be integrated into an existing flow. For example, a user generating and/or editing a workflow may identify a particular task that may be repeated or otherwise used across different flows and may use an associated component 432 to reduce time in generating the workflow. Different components 432 may be stored in one or more repositories, for exampled searchable data stores for easy access, and then may be integrated into one or more workflows.

In the illustrated example, the component 432 receives, as an input at the start 434, information from an operator 462 associated with the section 408A. The input triggers the execution of the component 432, which may then provide an outlet result or action, which may then trigger one or more additional flows, such as the flow in the section 408C. Accordingly, systems and methods of the present disclosure may be used to integrate existing components 432 into workflows, which may be pre-built and/or pre-verified, to streamline workflow generation while reducing a likelihood of errors with the different workflows.

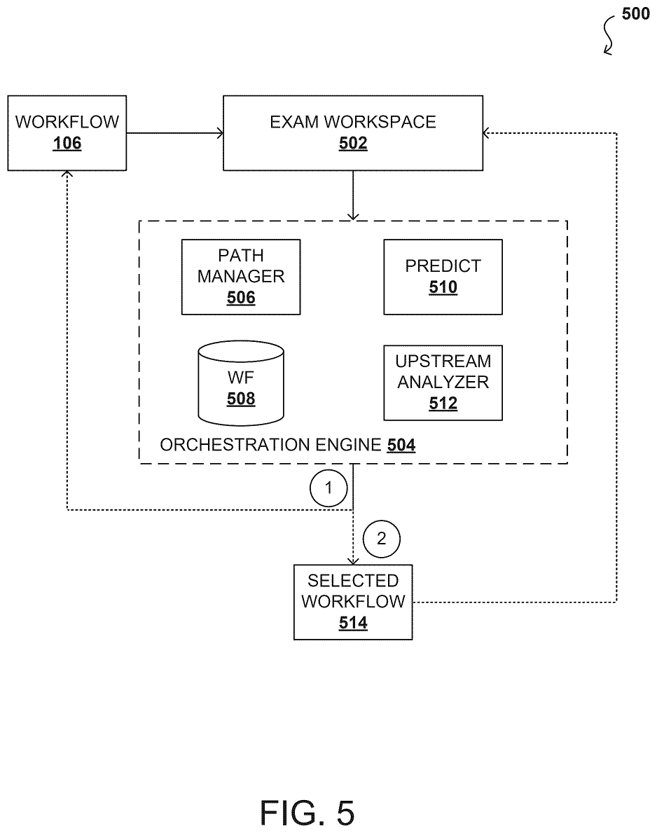

FIG. 5 illustrates an example environment 500 that may be used with embodiments of the present disclosure. In this example, a workflow 106 is executed within an examination workspace 502, for example after being visualized. A client may execute various steps of the workflow, which may include providing information responsive to one or more questions or providing access to one or more data sources, among other options. As the client executes the workflow, an orchestration engine 504 may monitor the overall orchestration of the workflow and associated evaluation and then dynamically adjust one or more portions of the workflow, such as by adding additional steps, adding new workflows, removing topics, and/or combinations thereof. For example, a path manager 506 may receive information regarding answers, decisions, actions, and the like from the workflow and then determine whether or not one or more modifications may be helpful. Modifications may include adding new workflows to expand a scope of the evaluation and/or skipping topics or sub-topics, among other options. A workflow datastore 508 may be used to extract and then execute one or more additional workflows, if it is determined to expand or modify the scope of the evaluation.

In one or more embodiments, one or more prediction engines 510 may be used to predict an outcome or likely path for a given workflow, which may be based on historical data processed by one or more machine learning systems, among other options. Additionally, an upstream analyzer 512 may then evaluate previous answers/decisions/actions to determine how to integrate previously entered information into a new workflow, thereby reducing the burden on the client. After evaluation, the orchestration engine 504 may then direct the client along different flows, where a flow indicated by the numeral 1 may illustrate continuing along the existing workflow 106 while a flow indicated by the numeral 2 may illustrate using a newly selected workflow 514 to continue the evaluation. In this manner, workflows may be dynamically adjusted based on input information. Upon completion of the workflow, one or more reports or summarizes may then be generated including salient information from the evaluation.

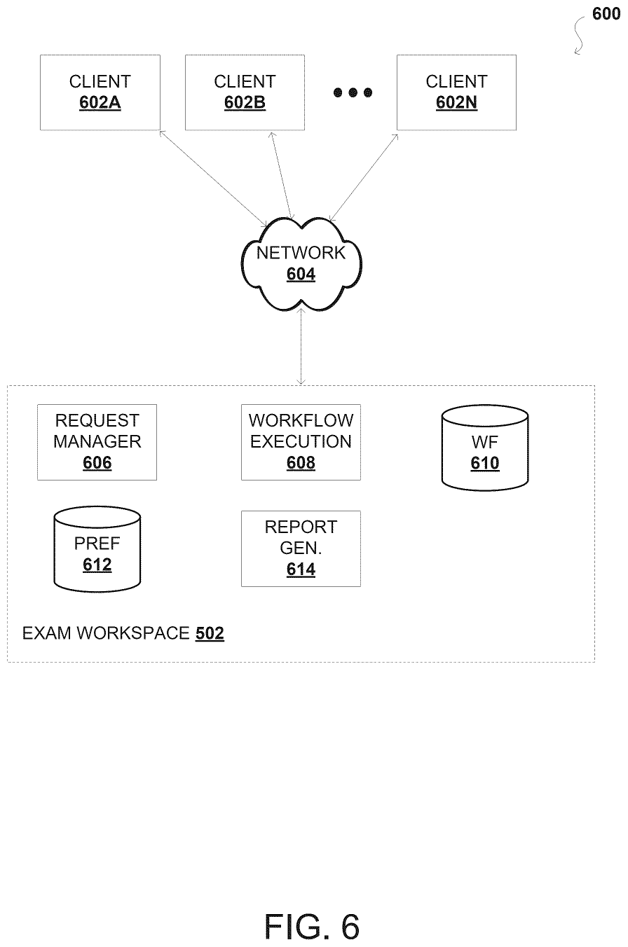

FIG. 6 illustrates an example environment 600 that may be used with embodiments of the present disclosure. In this example, the exam workspace 502 may be used to provide access to various resources to execute various functionality described herein. Systems and methods may be directed toward one or more applications, such as those executing on processors according to instructions stored on memory, on one or more client devices to provide communication services, such as chat services. As discussed herein, various features of the exam workspace 502 may be executed responsive to permissions provided by one or more users.

In operation, one or more clients 602A-602N may submit requests over one or more networks 604 to access and/or use features associated with the exam workspace 502. The clients 602A-602N may be represented by one or more client devices (e.g., client computing devices), which may serve as a proxy to the client/user by making requests responsive to one or more input commands. Additionally, a client may navigate to one or more applications or access points using the device to submit a request, among other options. As another example, a request may be transmitted as part of an automated or semi-automated workflow, which may or may not receive user interaction. Accordingly, one or more client computing devices, associated with the clients 602A-602N may be used with direct input from one or more users, from stored software instructions, from executions of various workflows, or combinations thereof. In at least one embodiment, the exam workspace 502 may be associated with a multi-tenant environment, where certain portions are protected or otherwise inaccessible to one or more tenants in the environment based, for example, upon one or more access restrictions.

The network(s) 106 can include any appropriate network, such as the Internet, a local area network (LAN), a cellular network, an Ethernet, or other such wired and/or wireless network. Furthermore, the exam workspace 502 may be associated with various resource provider environments, such as those that provide distributed computing services, which may include any appropriate resources for providing content and/or services, as may include various servers, data stores, and other such components. In various embodiments, the client devices can be any appropriate computing or processing device, as may include a desktop or notebook computer, smartphone, tablet, wearable computer (i.e., smart watch, glasses, or contacts), set top box, kiosk, interactive display, or other such system or device.

One or more requests may be submitted over the network 604 to be received at the exam workspace 502, for example at an interface layer that may service as a landing page or application program interface (API) to access different resources and/or content elements. User credentials may be checked prior to granting access to the content or resources within the exam workspace 502, for example using one or more user datastores that may store user information for a given service associated with the exam workspace 502. An authentication service may be associated with the datastores to verify different access credentials, such as a username, password, and/or the like. Furthermore, in at least one embodiment, the authentication service may also be used to establish new accounts for new users. For example, the authentication services may receive a request to establish a new account and then receive information associated with the new account, such as a desired username and/or password.

A request manager 606 may receive input from the various clients 602A-602N and may route them to one or more systems and/or sub-systems for processing and execution. For example, a request to log in may be routed to the authentication service and, upon successful authentication, a workflow execution engine 608 may obtain one or more workflows from a workflow datastore 610 to execute an evaluation, as discussed herein. In at least one embodiment, access to certain workflows in the workflow datastore 610 may be restricted or otherwise protected using one or more access control restrictions, such as credential requests and/or the like. Execution may include working through a workflow and interacting with one or more orchestration engines to guide completion of the evaluation. Upon completion, a report generator 614 may use one or more preferences in a preference datastore 612 to generate a summary report for the completed workflow. In at least one embodiment, access to certain preferences in the preference datastore 612 may be restricted or otherwise protected using one or more access control restrictions, such as credential requests and/or the like. In embodiments, the report generator 614 may include one or more machine learning systems, such as an LLM or a VLM, to receive an input from the workflow and generate a report.

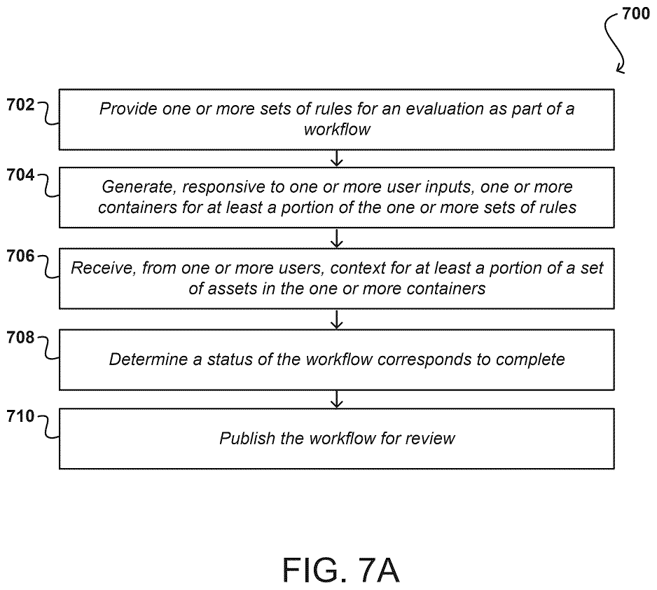

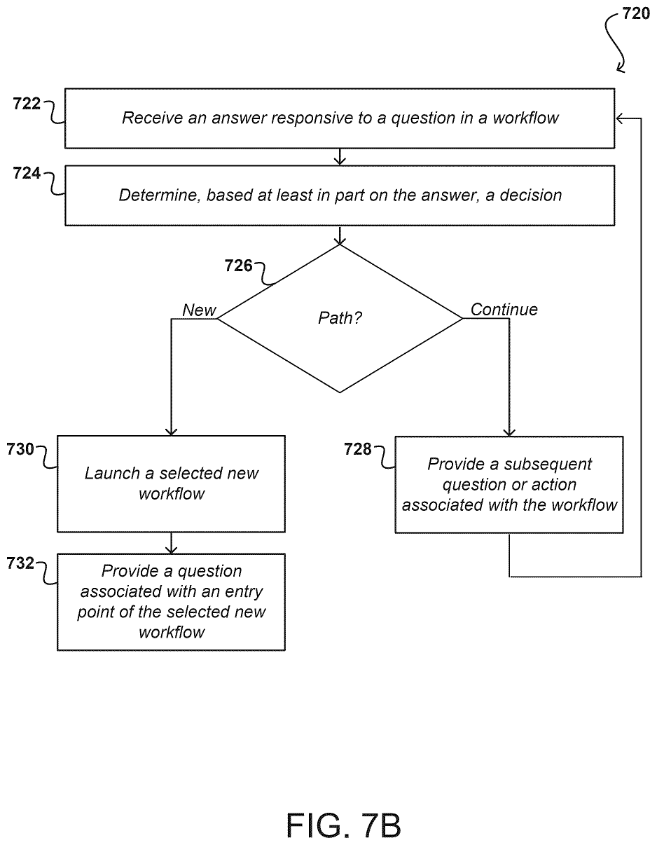

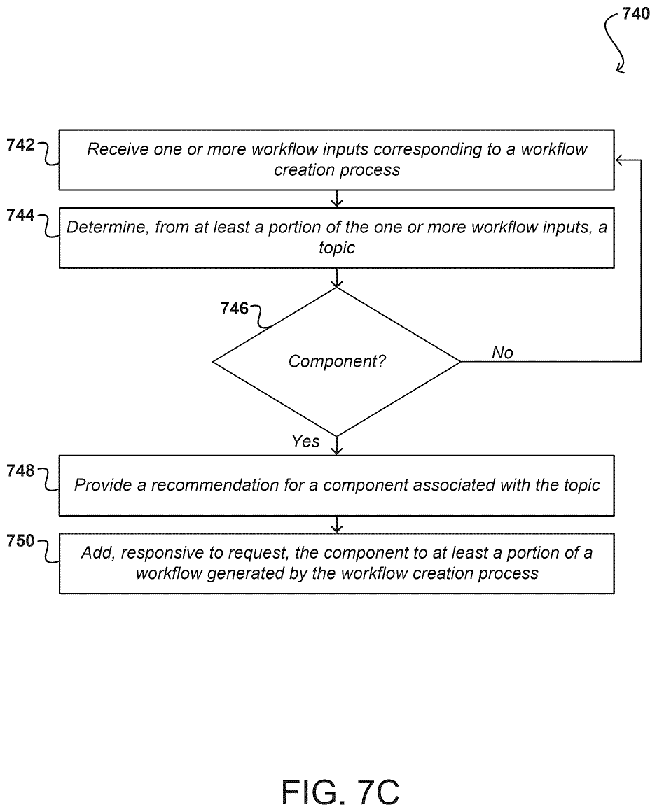

FIG. 7A is a flow chart of a method 700 for generating a workflow. It should be appreciated that steps for the method may be performed in any order, or in parallel, unless otherwise specifically stated. Moreover, the method may include more or fewer steps. In this example, one or more sets of rules for an evaluation as part of a workflow are provided 702. The sets of rules may include a logical process to make a determination based on one or more risks, as one example, and may further include proprietary thresholds or other evaluation techniques to assess one or more factors of the evaluation. In at least one embodiment, one or more containers are generated responsive to one or more user inputs 704. The containers may correspond to tasks, sub-tasks, and/or the like, and may organize a particular flow to assess one or more portions of the evaluation. Systems and methods may also receive, from one or more users, context for at least a portion of a set of assets in the one or more containers 706. Context may include a description of the information in the flows, a direction to provide particular datatypes, and/or the like. A status of the workflow may then be determined as complete 708 and the workflow may be published for review 710. In one or more embodiments, workflows are reviewed prior to publication and/or being made available for an evaluation, such as using one or more machine or human reviewers. The review may include a preview of a workflow visualization and/or a workflow or an interactive environment for executing the workflow. For example, review may include evaluating different links or decision paths for broken logic and/or to stress test evaluations to determine whether unintended paths are selected. In at least one embodiment, a machine reviewer may be used to provide randomized or semi-randomized answers to determine whether a workflow is sufficient for use for different evaluations. Review and approval may be accompanied by different record keeping functions, such as maintaining documentation regarding who reviewed a given workflow, who approved a given workflow, and/or the like. In this manner, sets of rules can be generated into logical workflows to evaluate one or more target questions, such as a risk assessment.

FIG. 7B is a flow chart of a method 720 for evaluating a workflow path. In this example, an answer is received responsive to a question in a workflow 722. The answer may be used to determine a decision 724. For example, the answer may be included as part of a logical evaluation of one or more thresholds. In at least one embodiment, a path may be selected 726. It may be determined to continue along an existing workflow path, and therefore a subsequent question or action associated with the workflow may be provided 728. However, information associated with the decision may be used to select a new path, in which case a new workflow may be launched 730 and a question associated with an entry point of the selected new workflow may be provided 732. In this manner, workflows may be adjusted dynamically based on input information.

FIG. 7C is a flow chart of a method 740 for adding a component to a workflow. In this example, one or more workflow inputs are received 742, which may be part of a workflow creation process. For example, a user may be adding different elements to a workflow to perform one or more evaluations, as discussed herein. A topic may be determined from at least a portion of the one or more workflow inputs 744. The topic may be associated with a type of evaluation being performed using the workflow inputs, a target outcome, and/or the like. It may then be determined whether or not an existing component associated with the topic is available 746. If not, additional inputs may be received until the workflow is generated. If so, then a recommendation may be provided for a component associated with the topic 748. For example, a pop up may be used to alert the user that a component is available to perform the task they are building out. The component may then be added, responsive to a request to at least a portion of a workflow generated by the workflow creation process 750. In this manner, workflow creation may be improved by identifying and recommending components for installation.

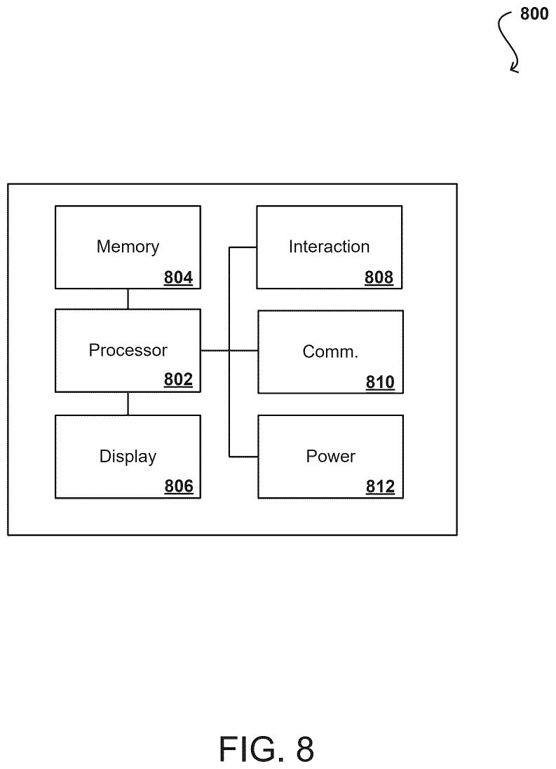

FIG. 8 illustrates a set of general components of an example computing device 800. In this example, the device includes a processor 802 for executing instructions that can be stored in a memory 804. The device can include many types of memory, data storage, or non-transitory computer-readable storage media, such as a first data storage for program instructions for execution by the processor 802, a separate storage for images or data, a removable memory for sharing information with other devices, etc. The device may optionally include a display element 806, such as a touch screen or liquid crystal display (LCD), although devices such as portable media players might convey information via other means, such as through audio speakers, and other devices may not include displays, such as server components executing within data centers, among other options. As discussed, the device in many embodiments will include at least one interaction component 808 able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all and might be controlled only through a combination of visual and audio commands, such that a user can control the device without having to be in contact with the device. In some embodiments, the computing device 800 of FIG. 8 can include one or more network interface or communication components 810 for communicating over various networks, such as a Wi-Fi, Bluetooth, RF, wired, or wireless communication systems. The device may be configured to communicate with a network, such as the Internet, and may be able to communicate with other such devices. The device will also include one or more power components 812, such as power cords, power ports, batteries, wirelessly powered or rechargeable receivers, and the like.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

Embodiments may also be described in view of the following clauses:
1. A computer-implemented method, comprising:
receiving an answer responsive to a question in a workflow associated with a risk assessment system;
determining, based at least in part on the answer and one or more thresholds, a decision along a first path of the workflow;
selecting, based at least in part on the decision, a second path associated with a second workflow;
launching the second workflow; and
providing, to a user associated with the answer, an entry point for the second workflow.
2. The computer-implemented method of clause 1, further comprising:
determining the second workflow is complete; and
returning to a second path of the workflow.
3. The computer-implemented method of clause 1, wherein the answer is provided by at least one of a user executing the workflow or a data source associated with the workflow.
4. The computer-implemented method of clause 3, further comprising:
identifying one or more features associated with the question; and
selecting the data source based, at least in part, on the one or more features.
5. The computer-implemented method of clause 1, further comprising:
receiving an input selecting a topic for an evaluation;
providing, responsive to the first input, a list of available workflows; and
launching, responsive to a second input, the workflow.
6. The computer-implemented method of clause 1, wherein the workflow includes at least one of a starting point, a question, a decision, or an action.
7. The computer-implemented method of clause 1, wherein the workflow includes at least two sections, having independent flows, forming a sub-topic for an evaluation, wherein a first section is connected to the second section via one or more flowlines.
8. The computer-implemented method of clause 7, wherein a selectable component, including an independent evaluation, forms at least a portion of at least one of the at least two sections.
9. A system, comprising:
one or more processors to:
   receive, within a workflow environment, a set of assets for executing one or more tasks along a workflow;
   receive, for at least a portion of the set of assets, contextual information describing features of the portion of the set of assets;
   receive access to one or more data sources associated with a target of the workflow;
   generate a configuration file for the workflow based, at least in part, on the set of assets and the contextual information; and
   generate, using the configuration file and one or more templates, an executable evaluation workflow.
10. The system of clause 9, wherein the workflow is associated with organizational evaluation and is directed toward a set of risks.
11. The system of clause 9, wherein the contextual information is extracted from a linked guidance context management system.
12. The system of clause 9, wherein the one or more processors are further to:
identify one or more features associated with at least one asset of the set of assets;
determine the one or more features correspond to a stored component; and
provide a recommendation to incorporate the component into the workflow.
13. The system of clause 12, wherein the component includes a plurality of assets for executing at least a first task of the one or more tasks.
14. The system of clause 9, wherein the one or more processors are further to:
determine a flowline for the set of assets satisfies one or more execution thresholds.
15. The system of clause 9, wherein the one or more processors are further to:
determine a flowline for the set of assets fails one or more execution thresholds; and
generate one or more alerts prior to permitting generation of the executable evaluation workflow.
16. The system of clause 9, wherein the executable evaluation workflow includes a visualized interface including at least the set of assets and associated contextual information.
17. A method, comprising:
receiving, within a workflow environment, a set of assets for executing one or more tasks along a workflow;
receiving, for at least a portion of the set of assets, contextual information describing features of the portion of the set of assets;
receiving access to one or more data sources associated with a target of the workflow;
generating a configuration file for the workflow based, at least in part, on the set of assets and the contextual information; and
generating, using the configuration file and one or more templates, an executable evaluation workflow.
18. The method of clause 17, further comprising:
identifying one or more features associated with at least one asset of the set of assets;
determining the one or more features correspond to a stored component; and
providing a recommendation to incorporate the component into the workflow.
19. The method of clause 18, wherein the component includes a plurality of assets for executing at least a first task of the one or more tasks.
20. The method of clause 17, further comprising:
determining a first flowline for the set of assets satisfies one or more execution thresholds;
determining a second flowline for the set of assets fails one or more execution thresholds; and
generating one or more alerts prior to permitting generation of the executable evaluation workflow.
21. A computer-implemented method, comprising:
receiving an answer responsive to a question in a workflow associated with a risk assessment system;
determining, based at least in part on the answer and one or more thresholds, a decision along a first path of the workflow;
selecting, based at least in part on the decision, a second path associated with a second workflow;
launching the second workflow; and
providing, to a user associated with the answer, an entry point for the second workflow.
22. The computer-implemented method of clause 21, further comprising:
determining the second workflow is complete; and
returning to a second path of the workflow.
23. The computer-implemented method of any of clauses 21 or 22, wherein the answer is provided by at least one of a user executing the workflow or a data source associated with the workflow.
24. The computer-implemented method of clause 23, further comprising:
identifying one or more features associated with the question; and
selecting the data source based, at least in part, on the one or more features.
25. The computer-implemented method of any of clauses 21-24, further comprising:
receiving an input selecting a topic for an evaluation;
providing, responsive to the first input, a list of available workflows; and
launching, responsive to a second input, the workflow.
26. The computer-implemented method of any of clauses 21-25, wherein the workflow includes at least one of a starting point, a question, a decision, or an action.
27. The computer-implemented method of any of clauses 21-26, wherein the workflow includes at least two sections, having independent flows, forming a sub-topic for an evaluation, wherein a first section is connected to the second section via one or more flowlines.
28. The computer-implemented method of clause 27, wherein a selectable component, including an independent evaluation, forms at least a portion of at least one of the at least two sections.
29. A system, comprising:
one or more processors to:
   receive, within a workflow environment, a set of assets for executing one or more tasks along a workflow;
   receive, for at least a portion of the set of assets, contextual information describing features of the portion of the set of assets;
   receive access to one or more data sources associated with a target of the workflow;
   generate a configuration file for the workflow based, at least in part, on the set of assets and the contextual information; and
   generate, using the configuration file and one or more templates, an executable evaluation workflow.
30. The system of clause 29, wherein the workflow is associated with organizational evaluation and is directed toward a set of risks.
31. The system of any of clauses 29 or 30, wherein the contextual information is extracted from a linked guidance context management system.
32. The system of any of clauses 29-31, wherein the one or more processors are further to:
identify one or more features associated with at least one asset of the set of assets;
determine the one or more features correspond to a stored component; and
provide a recommendation to incorporate the component into the workflow.
33. The system of clause 32, wherein the component includes a plurality of assets for executing at least a first task of the one or more tasks.
34. The system of any of clauses 29-33, wherein the one or more processors are further to:
determine a flowline for the set of assets satisfies one or more execution thresholds.
35. The system of any of clauses 29-34, wherein the one or more processors are further to:
determine a flowline for the set of assets fails one or more execution thresholds; and
generate one or more alerts prior to permitting generation of the executable evaluation workflow.
36. The system of any of clauses 29-35, wherein the executable evaluation workflow includes a visualized interface including at least the set of assets and associated contextual information.
37. A method, comprising:
receiving, within a workflow environment, a set of assets for executing one or more tasks along a workflow;
receiving, for at least a portion of the set of assets, contextual information describing features of the portion of the set of assets;
receiving access to one or more data sources associated with a target of the workflow;
generating a configuration file for the workflow based, at least in part, on the set of assets and the contextual information; and
generating, using the configuration file and one or more templates, an executable evaluation workflow.
38. The method of clause 37, further comprising:
identifying one or more features associated with at least one asset of the set of assets;
determining the one or more features correspond to a stored component; and
providing a recommendation to incorporate the component into the workflow.
39. The method of clause 38, wherein the component includes a plurality of assets for executing at least a first task of the one or more tasks.

40. The method of any of clauses 37-39, further comprising:
determining a first flowline for the set of assets satisfies one or more execution thresholds;
determining a second flowline for the set of assets fails one or more execution thresholds; and
generating one or more alerts prior to permitting generation of the executable evaluation workflow.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising:
receiving an answer responsive to a question in a workflow associated with a risk assessment system;
determining, based at least in part on the answer and one or more thresholds, a decision along a first path of the workflow;
selecting, based at least in part on the decision, a second path associated with a second workflow;
launching the second workflow; and
providing, to a user associated with the answer, an entry point for the second workflow.

2. The computer-implemented method of claim 1, further comprising:
determining the second workflow is complete; and
returning to a second path of the workflow.

3. The computer-implemented method of claim 1, wherein the answer is provided by at least one of a user executing the workflow or a data source associated with the workflow.

4. The computer-implemented method of claim 3, further comprising:
identifying one or more features associated with the question; and
selecting the data source based, at least in part, on the one or more features.

5. The computer-implemented method of claim 1, further comprising:
receiving an input selecting a topic for an evaluation;
providing, responsive to the first input, a list of available workflows; and
launching, responsive to a second input, the workflow.

6. The computer-implemented method of claim 1, wherein the workflow includes at least one of a starting point, a question, a decision, or an action.

7. The computer-implemented method of claim 1, wherein the workflow includes at least two sections, having independent flows, forming a sub-topic for an evaluation, wherein a first section is connected to the second section via one or more flowlines.

8. The computer-implemented method of claim 7, wherein a selectable component, including an independent evaluation, forms at least a portion of at least one of the at least two sections.

9. A system, comprising:
one or more processors to:
receive, within a workflow environment, a set of assets for executing one or more tasks along a workflow;
receive, for at least a portion of the set of assets, contextual information describing features of the portion of the set of assets;
receive access to one or more data sources associated with a target of the workflow;
generate a configuration file for the workflow based, at least in part, on the set of assets and the contextual information; and
generate, using the configuration file and one or more templates, an executable evaluation workflow.

10. The system of claim 9, wherein the workflow is associated with organizational evaluation and is directed toward a set of risks.

11. The system of claim 9, wherein the contextual information is extracted from a linked guidance context management system.

12. The system of claim 9, wherein the one or more processors are further to:
identify one or more features associated with at least one asset of the set of assets;
determine the one or more features correspond to a stored component; and
provide a recommendation to incorporate the component into the workflow.

13. The system of claim 12, wherein the component includes a plurality of assets for executing at least a first task of the one or more tasks.

14. The system of claim 9, wherein the one or more processors are further to:
determine a flowline for the set of assets satisfies one or more execution thresholds.

15. The system of claim 9, wherein the one or more processors are further to:
determine a flowline for the set of assets fails one or more execution thresholds; and
generate one or more alerts prior to permitting generation of the executable evaluation workflow.

16. The system of claim 9, wherein the executable evaluation workflow includes a visualized interface including at least the set of assets and associated contextual information.

17. A method, comprising:
receiving, within a workflow environment, a set of assets for executing one or more tasks along a workflow;
receiving, for at least a portion of the set of assets, contextual information describing features of the portion of the set of assets;
receiving access to one or more data sources associated with a target of the workflow;
generating a configuration file for the workflow based, at least in part, on the set of assets and the contextual information; and
generating, using the configuration file and one or more templates, an executable evaluation workflow.

18. The method of claim 17, further comprising:
identifying one or more features associated with at least one asset of the set of assets;
determining the one or more features correspond to a stored component; and
providing a recommendation to incorporate the component into the workflow.

19. The method of claim 18, wherein the component includes a plurality of assets for executing at least a first task of the one or more tasks.

20. The method of claim 17, further comprising:
determining a first flowline for the set of assets satisfies one or more execution thresholds;
determining a second flowline for the set of assets fails one or more execution thresholds; and
generating one or more alerts prior to permitting generation of the executable evaluation workflow.
